(19) United States
(12) Patent Application Publication
(10) Pub. No.: US 2025/0122634 A1
(43) Pub. Date: Apr. 17, 2025

(54) METHOD FOR PRODUCING ALKALI METAL ALCOHOLATES IN AN ELECTROLYSIS CELL

(71) Applicant: EVONIK OPERATIONS GMBH, Essen (DE)

(72) Inventors: Philip Heinrich REINSBERG, Rheinbach (DE); Michael HORN, Niederkassel (DE); Rüdiger TEUFERT, Köln (DE); Marc WEINER, Troisdorf (DE)

(73) Assignee: EVONIK OPERATIONS GMBH, Essen (DE)

(21) Appl. No.: 18/688,758

(22) PCT Filed: Aug. 19, 2022
(86) PCT No.: PCT/EP2022/073136

§ 371 Date: Mar. 2, 2024

(30) Foreign Application Priority Data
Sep. 6, 2021 (EP) 21195065.4

(51) Int. Cl. C25B 13/02; C01B 33/36; C25B 3/07; C25B 3/13; C25B 9/21; C25B 13/07; C25B 15/08

(52) U.S. Cl. CPC C25B 13/02; C01B 33/36; C25B 3/07; C25B 3/13; C25B 9/21; C25B 13/07; C25B 15/08

(57) ABSTRACT

The invention relates to a method for producing an alkali metal alcoholate solution L₁ in an electrolysis cell E which comprises at least one cathode chamber K_{K}, at least one anode chamber K_{A}, and at least one central chamber K_{M} lying therebetween. The interior I_{KK} of the cathode chamber K_{K} is separated from the interior I_{KM} of the central chamber K_{M} by a separating wall W comprising at least one alkali-cation-conductive solid ceramic electrolyte (=“AFK”) F (e.g. NaSICON). F has the surface O_{F}. A part O_{A/MK} of the surface O_{F} directly contacts the interior I_{KM}, and a part O_{KK} of the surface O_{F} directly contacts the interior I_{KK}. The surface O_{A/MK} and/or the surface O_{KK} comprises at least one part of a surface O_{FΔ}. O_{FΔ} is produced from a pre-treatment step in which F is produced from an AFK F′ comprising the surface O_{F′}. In the pre-treatment step, AFK is removed from F′ by sputtering the surface O_{F′} using noble gas cations N+, and the AFK F with the surface O_{F} comprising the surface O_{FΔ} formed by the sputtering process is obtained. During the electrolysis process for producing the alkali metal alcoholates with F instead of F′, an improved conductivity is provided, whereby for a constant current density, a lower voltage can be used.

The present invention relates to a process for producing an alkali metal alkoxide solution L₁ in an electrolysis cell E comprising at least one cathode chamber K_{K}, at least one anode chamber K_{A}, and at least one interposed middle chamber K_{M}.

The interior I_{KK} of the cathode chamber K_{K} is divided by a dividing wall W comprising at least one alkali metal cation-conducting solid-state electrolyte ceramic (=“ASC”) F (e.g. NaSICON) from the interior I_{KM} of the middle chamber K_{M}. F has the surface O_{F}, and a portion O_{A/MK} of this surface O_{F} makes direct contact with the interior I_{KM}, and a portion O_{KK} of this surface O_{F} makes direct contact with the interior I_{KK}.

The surface O_{A/MK} and/or the surface O_{KK} comprises at least a portion of a surface O_{FΔ}. O_{FΔ} results from a pretreatment step in which F is produced from an ASC F′ having the surface O_{F′}.

In the pretreatment step, by sputtering the surface O_{F′} with noble gas cations N⁺, ASC is removed from F′, and the ASC F is obtained with the surface O_{F} comprising the surface O_{FΔ} formed by the sputtering.

The electrolysis for production of the alkali metal alkoxides with F rather than F results in improved conductivity, which makes it possible to use a lower voltage at constant current density.

### 1. BACKGROUND OF THE INVENTION

The electrochemical production of alkali metal alkoxide solutions is an important industrial process which is described, for example, in DE 103 60 758 A1, US 2006/0226022 A1 and WO 2005/059205 A1. The principle of these processes is reflected in an electrolysis cell in which the solution of an alkali metal salt, for example sodium chloride or NaOH, is present in the anode chamber, and the alcohol in question or an alcoholic solution with a low concentration of the alkali metal alkoxide in question, for example sodium methoxide or sodium ethoxide, is present in the cathode chamber. The cathode chamber and the anode chamber are separated by a ceramic that conducts the alkali metal ion used, for example NaSICON or an analogue for potassium or lithium. On application of a current, chlorine forms at the anode—when a chloride salt of the alkali metal is used—and hydrogen and alkoxide ions at the cathode. The charge is balanced in that alkali metal ions migrate from the middle chamber into the cathode chamber via the ceramic that is selective therefor. The balancing of charge between middle chamber and anode chamber results from the migration of cations when cation exchange membranes are used or the migration of anions when anion exchange membranes are used, or from migration of both ion types when non-specific diffusion barriers are used. This increases the concentration of the alkali metal alkoxide in the cathode chamber, and the concentration of the sodium ions in the anolyte is lowered.

NaSICON solid-state electrolytes are also used in the electrochemical production of other compounds:

WO 2014/008410 A1 describes an electrolytic process for producing elemental titanium or rare earths. The basis of this process is that titanium chloride is formed from TiO₂ and the corresponding acid, and this is reacted with sodium alkoxide to give titanium alkoxide and NaCl and finally converted electrolytically to elemental titanium and sodium alkoxide.

WO 2007/082092 A2 and WO 2009/059315 A1 describe processes for producing biodiesel, in which, with the aid of alkoxides produced electrolytically by means of NaSICON, triglycerides are first converted to the corresponding alkali metal triglycerides and are reacted in a second step with electrolytically generated protons to give glycerol and the respective alkali metal hydroxide.

However, one disadvantage of the electrolysis cells described in the prior art is that the resistance of the solid-state electrolyte ceramics used therein is relatively high. This increases the specific energy consumption of the electrolytically produced materials, and there is also a deterioration in the energy-specific data (current, voltage) of the cell. Ultimately, the overall process becomes uneconomic.

It was accordingly an object of the present invention to provide a process for producing an alkali metal alkoxide solution in an electrolysis cell, which does not have this disadvantage.

A further disadvantage of conventional electrolysis cells in this technical field arises from the fact that the solid-state electrolyte does not have long-term stability with respect to aqueous acids. This is problematic in that, during the electrolysis in the anode chamber, the pH falls as a result of oxidation processes (for example in the case of production of halogens by disproportionation or by oxygen formation). These acidic conditions attack the NaSICON solid-state electrolyte to such a degree that the process cannot be used on an industrial scale. In order to counter this problem, various approaches have been described in the prior art.

For instance, three-chamber cells have been proposed in the prior art. These are known in the field of electrodialysis, for example U.S. Pat. No. 6,221,225 B1.

WO 2012/048032 A2 and US 2010/0044242 A1 describe, for example, electrochemical processes for producing sodium hypochlorite and similar chlorine compounds in such a three-chamber cell. The cathode chamber and the middle chamber of the cell are separated here by a solid-state electrolyte permeable to cations, for example NaSICON. In order to protect this from the acidic anolyte, the middle chamber is supplied, for example, with solution from the cathode chamber. US 2010/0044242 A1 also describes, in FIG. 6, the possibility of mixing solution from the middle chamber with solution from the anode chamber outside the chamber in order to obtain sodium hypochlorite.

Such cells have also been proposed in the prior art for the production or purification of alkali metal alkoxides.

For instance, U.S. Pat. No. 5,389,211 A describes a process for purifying alkoxide solutions in which a three-chamber cell is used, in which the chambers are delimited from one another by cation-selective solid-state electrolytes or else nonionic dividing walls. The middle chamber is used as buffer chamber in order to prevent the purified alkoxide or hydroxide solution from the cathode chamber from mixing with the contaminated solution from the anode chamber.

DE 42 33 191 A1 describes the electrolytic recovery of alkoxides from salts and alkoxides in multichamber cells and stacks of multiple cells.

WO 2008/076327 A1 describes a process for producing alkali metal alkoxides. This uses a three-chamber cell, the middle chamber of which has been filled with alkali metal alkoxide (see, for example, paragraphs [0008] and [0067] of WO 2008/076327 A1). This protects the solid-state electrolyte separating the middle chamber and the cathode chamber from the solution present in the anode chamber, which becomes more acidic in the course of electrolysis. A similar arrangement is described by WO 2009/073062 A1. However, this arrangement has the disadvantage that the alkali metal alkoxide solution which is consumed as buffer solution and continuously contaminated is the desired product. A further disadvantage of the process described in WO 2008/076327 A1 is that the formation of the alkoxide in the cathode chamber depends on the diffusion rate of the alkali metal ions through two membranes or solid-state electrolytes. This in turn leads to slowing of the formation of the alkoxide.

A further problem results from the geometry of the three-chamber cell. The middle chamber in such a chamber is separated from the anode chamber by a diffusion barrier and from the cathode chamber by an ion-conducting ceramic. During the electrolysis, this results unavoidably in development of pH gradients and in dead volumes. This can damage the ion-conducting ceramic and, as a result, increase the voltage demand of the electrolysis and/or lead to fracture of the ceramic.

While this effect takes place throughout the electrolysis chamber, the drop in pH is particularly critical in the middle chamber since this is bounded by the ion-conducting ceramic. Gases are typically formed at the anode and the cathode, such that there is at least some degree of mixing in these chambers. By contrast, no such mixing takes place in the middle chamber, such that the pH gradient develops therein. This unwanted effect is enhanced by the fact that the brine is generally pumped relatively slowly through the electrolysis cell.

A further object of the present invention was accordingly that of providing an improved process for electrolytic production of alkali metal alkoxide. This is not to have the aforementioned disadvantages, and is especially to assure improved protection of the solid-state electrolyte prior to the formation of the pH gradient and more sparing use of the reactants compared to the prior art.

### 2. BRIEF DESCRIPTION OF THE INVENTION

The objects of the invention are achieved by the process according to Claim 1.

### 3. FIGURES

The figures show preferred embodiments of the process according to the invention.

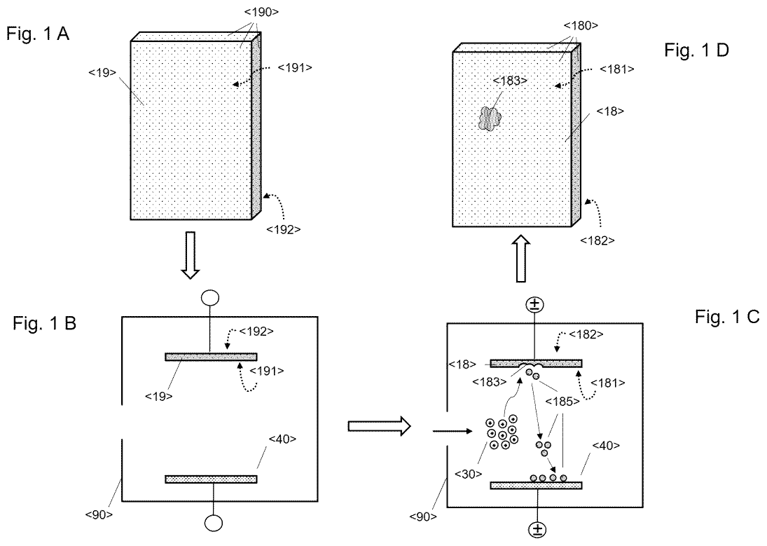

### 3.1 FIGS. 1A to 1D

FIGS. 1A (=“FIG. 1A”), 1B (=“FIG. 1B”), 1C (=“FIG. 1C”), and 1D (=“FIG. 1D”) illustrate steps (i) and (ii) of the process according to the invention.

FIG. 1A shows an alkali metal cation-conducting solid-state electrolyte ceramic F′ <19>, as provided in step (i). This has a surface O_{F} <190>. The surface O_{F} <190> comprises, for example, two subregions; in FIG. 1A, these are the opposite areas identified by reference numerals <191> and <192>, of which the rear one <192> is hidden.

The ASC F′ <19>, as shown in FIG. 1B, is disposed in a process chamber <90> as “target” with respect to a substrate film <40> such that the surface subregion <191> lies opposite the film <40>, while the surface subregion <192> faces away from it. The substrate film <40> is optional, since the sputtering of the target can also be undertaken without it.

FIG. 1C shows the step of sputtering, in which the HF (high frequency; also “radiofrequency”, “RF”) variant is employed. In the process chamber <90>, under fine vacuum, (10⁻¹ to 10⁻² mbar), a plasma of argon cations N⁺ <30> and electrons is generated, and an AC field (indicated by the symbol “±”) with a negative offset voltage at the target, the ASC F′ <19>, is generated by means of a high-frequency voltage source connected in series with a capacitor and the plasma (not shown in FIG. 1C).

The argon anions N⁺ <30> are accelerated in the direction of the target ASC F′ <19> and strip ASC away from it. The dust particles <185> thus generated are scattered in the direction of the substrate <40> and are precipitated there (and on the walls of the process chamber <90>).

This process step affords an ASC F <18>, the surface O_{F} <180> of which has a part-surface O_{A/MK} <181> facing the substrate <40> and a part-surface O_{KK} <182> facing away from the substrate <40>. O_{A/MK} <181> in turn comprises a subregion O_{FΔ} <183> that has formed by virtue of removal of ASC from F′ <19> by means of sputtering.

FIG. 1D shows the ASC F <18> thus obtained, which is obtained after step (ii). This has a surface O_{F} <180>. The surface O_{F} <180> comprises the two subregions O_{A/MK} <181> and O_{KK} <182>. F <18> corresponds to F′ <19>, or the surface O_{F} <180> corresponds to the surface O_{F′}<190>, with the difference that O_{A/MK} <181> includes the subregion O_{FΔ} <183>. On account of this subregion O_{FΔ} <183>, S_{MF}, which is the mass-based specific surface area S_{M} of the ASC F <18>, is greater than S_{MF′}, which is the mass-based specific surface area S_{M} of the ASC F′ <19>.

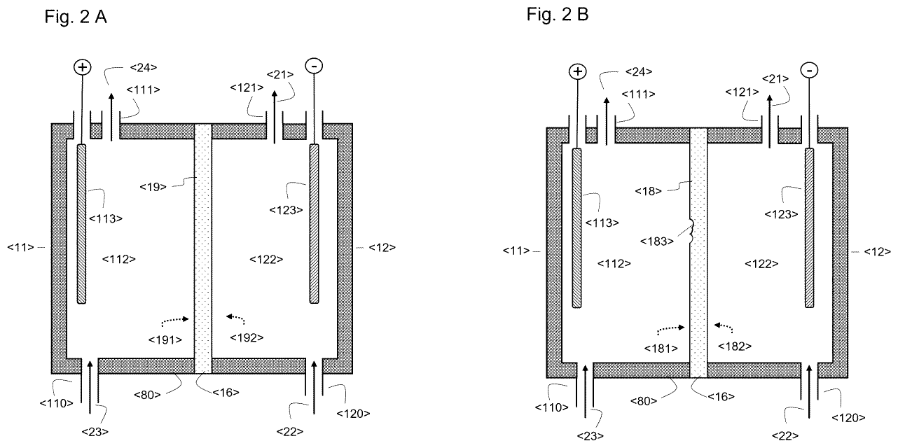

### 3.2 FIGS. 2A and 2B

FIG. 2A (=“FIG. 2A”) shows a noninventive embodiment in the form of an electrolysis cell which is a two-chamber cell.

This electrolysis cell comprises a cathode chamber K_{K} <12> and an anode chamber K_{A} <11>.

The anode chamber K_{A} <11> comprises an anodic electrode E_{A} <113> in the interior I_{KA} <112>, an inlet Z_{KA} <110> and an outlet A_{KA} <111>.

The cathode chamber K_{K} <12> comprises a cathodic electrode E_{K} <123> in the interior I_{KK} <122>, an inlet Z_{KK} <120> and an outlet A_{KK} <121>.

The electrolysis cell is bounded by an outer wall W_{A} <80>.

The interior I_{KK} <122> is also divided from the interior I_{KA} <112> by a dividing wall W <16> consisting of a sheet of an NaSICON solid-state electrolyte ceramic F′ <19> which is selectively permeable to sodium ions and has a surface O_{F′}<190>. The NaSICON solid-state electrolyte ceramic F′ <19> extends over the entire depth and height of the two-chamber cell. The NaSICON solid-state electrolyte ceramic F′ <19> makes direct contact with the two interiors I_{KK} <122> and I_{KA} <112> via the part-surfaces <192> and <191>, such that sodium ions can be routed from one interior into the other through the NaSICON solid-state electrolyte ceramic F′ <19>. In FIGS. 2A and 2B, the respective alkali metal cation-conducting solid-state electrolyte ceramic F′ <19> or F <18> is arranged in the respective electrolysis cell such that the area shaded in FIGS. 1A and 1D faces the user in FIGS. 2A and 2B.

An aqueous solution of sodium chloride L₃ <23> with pH 10.5 is introduced via the inlet Z_{KA} <110>, counter to the direction of gravity, into the interior I_{KA} <112>.

A solution of sodium methoxide in methanol L₂ <22> is routed into the interior I_{KK} <122> via the inlet Z_{KK} <120>.

At the same time, a voltage is applied between the cathodic electrode E_{K} <123> and the anodic electrode E_{A} <113>. This results in reduction of methanol in the electrolyte L₂ <22> to give methoxide and H₂ in the interior I_{KK} <122> (CH₃OH+e⁻→CH₃O⁻+½ H₂). At the same time, sodium ions diffuse from the interior I_{KA} <112> through the NaSICON solid-state electrolyte F <18> into the interior I_{KK} <122>. Overall, this increases the concentration of sodium methoxide in the interior I_{KK} <122>, which affords a methanolic solution of sodium methoxide L₁ <21> having an elevated sodium methoxide concentration compared to L₂ <22>.

In the interior I_{KA} <112>, the oxidation of chloride ions takes place to give molecular chlorine (Cl⁻→½ Cl₂+e⁻). In the outlet A_{KA} <111>, an aqueous solution L₄ <24> is obtained, in which the content of NaCl is reduced compared to L₃ <23>. Chlorine gas (Cl₂) forms in water, according to the reaction Cl₂+H₂O→HOCl+HCl, hypochlorous acid and hydrochloric acid, which give an acidic reaction with further water molecules. The acidity damages the NaSICON solid-state electrolyte ceramic F′ <19>.

FIG. 2B (=“FIG. 2B”) shows a further embodiment of a noninventive process. The electrolysis cell E corresponds to the arrangement shown in FIG. 2A, with the difference that a NaSICON solid-state electrolyte ceramic F <18> which has the surface O_{F} <180> and has been pretreated by the method according to FIGS. 1A to 1D is utilized as dividing wall W <16>. F <18> has a part-surface O_{KK} <182> that makes direct contact with the interior I_{KK} <122> and a part-surface O_{A/MK} <181> that makes direct contact with the interior I_{KA} <112>. The NaSICON solid-state electrolyte F <18> was obtained by a sputtering method in accordance with FIGS. 1A to 1D. The NaSICON solid-state electrolyte ceramic F <18> obtained has, by contrast with F′ <19>, the subregion O_{FΔ}<183> that has formed as a result of the sputtering method on the part-surface O_{A/MK} <181>. As a result, the NaSICON solid-state electrolyte ceramic F <18> has a greater mass-based specific surface area S_{MF} than that (S_{MF′}) of the alkali metal cation-conducting solid-state electrolyte ceramic F′ <19>. This leads to better conductivity, i.e. to a reduction in voltage at the same current density during electrolysis, which leads to an energy-saving.

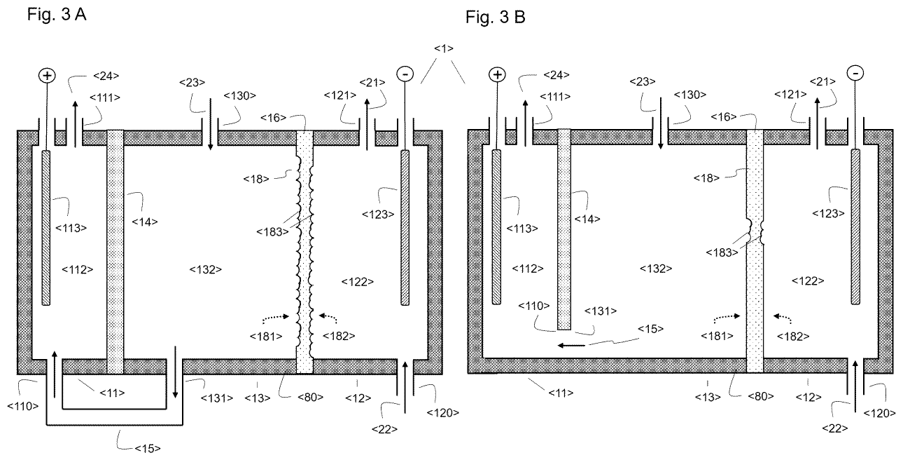

### 3.3 FIGS. 3A and 3B

FIG. 3A (=“FIG. 3A”) shows one embodiment of the process according to the invention.

It show the process according to the invention in the form of an electrolysis cell E <1> which is a three-chamber cell.

The three-chamber electrolysis cell E <1> comprises a cathode chamber K_{K} <12>, an anode chamber K_{A} <11> and an interposed middle chamber K_{M} <13>.

The anode chamber K_{A} <11> comprises an anodic electrode E_{A} <113> in the interior I_{KA} <112>, an inlet Z_{KA}<110> and an outlet A_{KA} <111>.

The cathode chamber K_{K} <12> comprises a cathodic electrode E_{K} <123> in the interior I_{KK} <122>, an inlet Z_{KK} <120> and an outlet A_{KK} <121>.

The middle chamber K_{M} <13> comprises an interior I_{KM} <132>, an inlet Z_{KM} <130> and an outlet A_{KM} <131>. The interior I_{KA} <112> is connected to the interior I_{KM} <132> via the connection V_{AM} <15>.

The electrolysis cell E <1> is bounded by an outer wall W_{A} <80>.

The interior I_{KK} <122> is also divided from the interior I_{KM} <132> by a dividing wall W <16> consisting of a sheet of an NaSICON solid-state electrolyte ceramic F <18> which is selectively permeable to sodium ions and has the surface O_{F} <180>. This surface has a part-surface O_{KK} <182> that makes direct contact with the interior I_{KK} <122> and a part-surface O_{A/MK} <181> that makes direct contact with the interior I_{KM} <132>. The NaSICON solid-state electrolyte ceramic F <18> extends over the entire depth and height of the three-chamber cell E <1>. F <18> is obtained by a sputtering method corresponding to the method shown in FIGS. 1A to 1D from the NaSICON solid-state electrolyte F′ <19> and, by contrast with F′ <19>, has the subregion O_{FΔ}<183> that has formed as a result of process step (ii) on the part-surface O_{A/MK}<181>. Compared to the NaSICON solid-state electrolyte ceramic F <18> shown in FIG. 2B, the surface O_{FΔ} <183> obtained by process step (ii) is larger in the NaSICON solid-state electrolyte ceramic F <18> according to FIG. 3A. In addition, not only was the part-surface O_{A/MK}<181> sputtered, but also the part-surface O_{KK} <182>, which still further increases the mass-based specific surface area S_{MF}. This more extended processing is achieved by sputtering over a larger area on both sides of F′ <19>.

As a result, the NaSICON solid-state electrolyte F <18> has an even greater mass-based specific surface area S_{MF} than that (S_{MF′}) of the alkali metal cation-conducting solid-state electrolyte ceramic F′ <19>. This leads to an even better conductivity.

F <18> makes direct contact with the two interiors I_{KK} <122> and I_{KM} <132>, such that sodium ions can be routed from one interior into the other through the NaSICON solid-state electrolyte ceramic F <18>.

The interior I_{KM} <132> of the middle chamber K_{M} <13> is additionally divided in turn from the interior I_{KA} <112> of the anode chamber K_{A} <11> by a diffusion barrier D <14>. The NaSICON solid-state electrolyte ceramic F <18> and the diffusion barrier D <14> extend over the entire depth and height of the three-chamber cell E <1>. The diffusion barrier D <14> is a cation exchange membrane (sulfonated PTFE).

In the embodiment according to FIG. 3A, the connection V_{AM} <15> is formed outside the electrolysis cell E <1>, especially by a tube or hose, the material of which may be selected from rubber, metal and plastic. The connection V_{AM} <15> can guide liquid from the interior I_{KM} <132> of the middle chamber K_{M} <13> into the interior I_{KA} <112> of the anode chamber K_{A} <11> outside the three-chamber cell E <1>. The connection V_{AM} <15> connects an outlet A_{KM} <131> that penetrates the outer wall W_{A} <80> of the electrolysis cell E <1> at the base of the middle chamber K_{M} <13> to an inlet Z_{KA}<110> that penetrates the outer wall W_{A} <80> of the electrolysis cell E at the base of the anode chamber K_{A} <11>.

An aqueous solution of sodium chloride L₃ <23> with pH 10.5 is introduced via the inlet Z_{KM} <130>, in the direction of gravity, into the interior I_{KM} <132> of the middle chamber K_{M} <13>. The connection V_{AM} <15> formed between the outlet A_{KM} <131> from the middle chamber K_{M} <13> and an inlet Z_{KA}<110> to the anode chamber K_{A} <11> connects the interior I_{KM} <132> of the middle chamber K_{M} <13> to the interior I_{KA} <112> of the anode chamber K_{A} <11>. Sodium chloride solution L₃ <23> is routed through this connection V_{AM} <15> from the interior I_{KM} <132> into the interior I_{KA} <112>.

A solution of sodium methoxide in methanol L₂ <22> is routed into the interior I_{KK} <122> via the inlet Z_{KK} <120>.

At the same time, a voltage is applied between the cathodic electrode E_{K} <123> and the anodic electrode E_{A} <113>. This results in reduction of methanol in the electrolyte L₂ <22> to give methoxide and H₂ in the interior I_{KK} <122> (CH₃OH+e⁻→CH₃O⁻+½ H₂). At the same time, sodium ions diffuse from the interior I_{KM} <132> of the middle chamber K_{M} <103> through the NaSICON solid-state electrolyte F <18> into the interior I_{KK} <122>. Overall, this increases the concentration of sodium methoxide in the interior I_{KK} <122>, which affords a methanolic solution of sodium methoxide L₁ <21> having an elevated sodium methoxide concentration compared to L₂ <22>.

In the interior I_{KA} <112>, the oxidation of chloride ions takes place to give molecular chlorine (Cl⁻→½ Cl₂+e⁻). In the outlet A_{KA} <111>, an aqueous solution L₄ <24> is obtained, in which the content of NaCl is reduced compared to L₃ <23>. Chlorine gas (Cl₂) forms in water, according to the reaction Cl₂+H₂O→HOCl+HCl, hypochlorous acid and hydrochloric acid, which give an acidic reaction with further water molecules. The acidity would damage the NaSICON solid-state electrolyte F <18>, but is restricted to the anode chamber K_{A} <11> by the arrangement in the three-chamber cell, and hence kept away from the NaSICON solid-state electrolyte ceramic F <18> in the electrolysis cell E. This considerably increases the lifetime thereof.

FIG. 3B (=“FIG. 3B”) shows a further embodiment of the process according to the invention. This is conducted in an electrolysis cell E <1> which corresponds to the electrolysis cell E <1> shown in FIG. 3A, with the following difference:

The connection V_{AM} <15> from the interior I_{KM} <132> of the middle chamber K_{M} <13> to the interior I_{KA} <112> of the anode chamber K_{A} <11> is formed not outside the electrolysis cell E <1>, but rather inside the electrolysis cell E <1>, through a perforation in the diffusion barrier D <14>. This perforation may be introduced into the diffusion barrier D <14> subsequently (for instance by stamping, drilling) or may already have been present therein from the outset on account of the production of the diffusion barrier D <14> (for example in the case of textile fabrics such as filter cloths or metal weaves).

As in the embodiment according to FIG. 3A, not only is the part-surface O_{A/MK}<181> sputtered, but also part-surface O_{KK} <182>, which still further increases the mass-based specific surface area S_{MF}. However, O_{FΔ} <183> is smaller than in the embodiment according to FIG. 3A.

### 4. DETAILED DESCRIPTION OF THE INVENTION

### 4.1 Step (i)

In step (i) of the process according to the invention, an alkali metal cation-conducting solid-state electrolyte ceramic (=“ASC”) F′ having the surface O_{F′} is provided.

The ASC F′ provided in step (i) is subjected to step (ii) in the process according to the invention and, after step (ii), the ASC F is obtained with the surface O_{F}. Since F is essentially obtained from F′ by removing a portion of ASC from F′ in step (ii) in order to arrive at F, F′ and F have essentially the same chemical structure.

A useful alkali metal cation-conducting solid-state electrolyte ceramic F′, and especially also F, is any solid-state electrolyte by which cations, especially alkali metal cations, even more preferably sodium cations, can be transported from I_{KM} into I_{KK}. Such solid-state electrolytes are known to the person skilled in the art and are described, for example, in DE 10 2015 013 155 A1, in WO 2012/048032 A2, paragraphs [0035], [0039], [0040], in US 2010/0044242 A1, paragraphs [0040], [0041], in DE 10360758 A1, paragraphs [014] to [025]. They are sold commercially under the NaSICON, LiSICON, KSICON name. A sodium ion-conducting solid-state electrolyte ceramic F is preferred, and this even more preferably has an NaSICON structure. NaSICON structures usable in accordance with the invention are also described, for example, by N. Anantharamulu, K. Koteswara Rao, G. Rambabu, B. Vijaya Kumar, Velchuri Radha, M. Vithal, J Mater Sci 2011, 46, 2821-2837.

In a preferred embodiment, the alkali metal cation-conducting solid-state electrolyte ceramic F, and especially also F, has an NaSICON structure of the formula

M^{I}_{1+2w+x-y+z}M^{II}_{w}M^{III}ₓZr^{IV}_{2-w-x-y}M^{V}_{y}(SiO₄)_{z}(PO₄)_{3-z}.

M^{I} here is selected from Na⁺, Li⁺, preferably Na⁺.

M^{II} here is a divalent metal cation, preferably selected from Mg²⁺, Ca²⁺, Sr²⁺, Ba²⁺, Co²⁺, Ni²⁺, more preferably selected from Co²⁺, Ni²⁺.

M^{III} here is a trivalent metal cation, preferably selected from Al³⁺, Ga³⁺, Sc³⁺, La³⁺, Y³⁺, Gd³⁺, Sm³⁺, Lu³⁺, Fe³⁺, Cr³⁺, more preferably selected from Sc³⁺, La³⁺, Y³⁺, Gd³⁺, Sm³⁺, especially preferably selected from Sc³⁺, Y³⁺, La³⁺.

M^{V} here is a pentavalent metal cation, preferably selected from V⁵⁺, Nb⁵⁺, Ta⁵⁺.

The Roman indices I, II, III, IV, V indicate the oxidation numbers in which the respective metal cations exist.

w, x, y, z are real numbers, where 0≤x<2, 0≤y<2, 0≤w<2, 0≤z<3,
and where w, x, y, z are chosen such that 1+2w+x−y+z≥0 and 2−w−x−y≥0.

Even more preferably in accordance with the invention, the NaSICON structure has a structure of the formula Na₍₁₊ᵥ₎Zr₂SiᵥP₍₃₋ᵥ₎O₁₂ where v is a real number for which 0≤v≤3. Most preferably, v=2.4.

In a preferred embodiment of the process according to the invention, the alkali metal cation-conducting solid-state electrolyte ceramics F and F have the same structure.

### 4.2 Step (ii)

In step (ii) of the process according to the invention, a portion of the alkali metal cation-conducting solid-state electrolyte ceramic F′ is removed by sputtering with noble gas cations N⁺, preferably cations of argon, neon, krypton, xenon, even more preferably cations of argon.

The noble gas cations N⁺ are present in step (ii) in the form of plasma in particular.

This affords an alkali metal cation-conducting solid-state electrolyte ceramic F with the surface O_{F}, where the surface O_{F} differs from the surface OF′ in at least one subregion O_{FΔ}, and where the surface O_{F} comprises the surfaces O_{A/MK} and O_{KK}, where O_{A/MK} and/or O_{KK} comprise at least a portion of O_{FΔ}, and where in particular O_{A/MK} and O_{KK} comprise at least a portion of O_{FΔ.}

### 4.2.1 Sputtering

“Sputtering” (“atomizing”) is a method known to the person skilled in the art for treatment of surfaces, which is described by the following authors for example:
Chapter 7 (“Sputtern”; pages 147-190) of the book “Oberflächentechnologie mit Niederdruckplasmen” [Surface Technology with Low-Pressure Plasmas] by Gerhard Franz, 1994, Springer-Verlag Berlin Heidelberg;
D. Horwat, J. F. Pierson, A. Billard, Surface & Coatings Technology 2007, 201, 7013-7017 and 7060-7065;
V. A. Sugiawati, F. Vacandio, M. Eyraud, P. Knauth, T. Djenizian, Nanoscale Research Letters 2016, 11, 365;
D. Depla, S. Mahieu, J. E. Greene, “Sputter Deposition Processes” (Seiten 253-296) in “Handbook of deposition technologies for films and coatings: science, applications and technology”, (ed.: P. M. Martin), 3rd edition, 2010, Oxford.

In general, the sputtering involves treating the surface of a particular body.

In step (ii), the sputtering with noble gas cations N⁺ partly strips ASC away from F′.

The conditions of the sputtering, especially the generation of a plasma of the noble gas cations N⁺, the arrangement of the ASC F′, the power with which the noble gas cations N⁺ are shot onto the surface O_{F′} of the ASC F′ (i.e. their energy), can be established by the person skilled in the art in accordance with their knowledge in the art.

The extent to which ASC is stripped from F′ can likewise be controlled by the person skilled in the art via the selection of the noble gas N, the adjustment of the energy of N⁺ and the time for which F′ is sputtered.

For this purpose, F′ is preferably disposed in a suitable process chamber.

In particular, a high vacuum (especially 10⁻⁴ to 10⁻¹, preferably 10⁻² to 10⁻¹ mbar) is applied in the process chamber, a noble gas N is introduced and an electrical field is generated, in which the body to be treated (the “target”) is set up as one pole, as the cathode for example in the case of DC sputtering.

The electrical field, according to the sputtering variant, may be a DC field (“DC sputtering”) or an AC field [“high-frequency (HF) sputtering” or “radiofrequency (RF) sputtering” ]. The latter is typically generated by series connection of a high-frequency voltage source with a capacitor and the plasma. Optionally, the electrical field may also be overlaid with a magnetic field. Especially in the case of targets having insufficient conductivity, preference is given to working in an alternating field in order to avoid charging of the target.

In step (ii) of the process according to the invention, preference is given to applying an alternating field in the sputtering operation.

The electrical field generates a plasma of noble gas cations N⁺ that are accelerated in the direction of the target, where they “knock out”, i.e. strip, atoms from the target. The adjustment of the energy of the noble gas cations N⁺ which is required for the purpose may be undertaken by the person skilled in the art in accordance with their knowledge in the art. The person skilled in the art is aware here of what energy of the noble gas cations N⁺ has to be established for them to strip away a maximum proportion of ASC at the surface O_{F′} and to cause a minimum proportion of unwanted side reactions, for example incorporation of N⁺ into the lattice structure of F′.

In step (ii) of the process according to the invention, the noble gas cations N⁺ preferably have an energy in the range from 1 to 100 keV, more preferably in the range from 5 to 70 keV, even more preferably in the range from 10 to 50 keV, even more preferably in the range from 20 to 40 keV. The energy may be determined by the person skilled in the art using their knowledge in the art (for example by adjusting the strength of the alternating field or DC field depending on the particular noble gas N used). Within these ranges, it is assured to a particularly high degree that ASC is stripped away by sputtering, and side effects such as incorporation of N⁺ into the crystal structure of the ASC are suppressed.

The duration over which the surface O_{F′} is sputtered with noble gas cations N⁺ is especially >1 min, preferably more than 30 min, preferably more than 60 min, even more preferably more than 120 min.

In step (ii) of the process according to the invention, noble gas cations NW are used. These are preferably in the form of a plasma.

Preference is given here to generating a plasma of the noble gas cations N in an alternating field, which is even more preferably overlaid with a magnetic field. The noble gas cations N⁺ are preferably those in which the noble gas N is selected from the group consisting of helium, neon, argon, krypton, xenon, radon, more preferably from the group consisting of neon, argon, krypton, xenon, more preferably from argon, krypton, xenon. Most preferably, the noble gas cations N⁺ are argon cations.

In an optional embodiment, the noble gas cations N⁺ are present in a mixture with a reactive gas, especially selected from nitrogen, oxygen, preferably nitrogen. This gas increases the stripping rate of the ASC from F′, since it can react with the stripped ASC particles.

In step (ii) of the process according to the invention, the pressure is preferably within a range from 10⁻⁴ to 10⁻¹ mbar, more preferably in the range from 10⁻³ to 10⁻¹ mbar, even more preferably in the range from 10⁻² to 10⁻¹ mbar.

The sputtering in step (ii) can treat the entire surface O_{F′}. This is possible in that, for example, a portion of the surface O_{F′} is first sputtered in a first substep, especially facing the plasma and hence the noble gas cations N⁺ and being sputtered thereby, and ASC is stripped away in this portion of the surface O_{F′}, and then, in a second substep, the side of F′ that the plasma has not reached in the first substep is sputtered, especially facing the plasma and hence the noble gas cations N⁺ and being sputtered thereby, and hence stripping away ASC there.

If the entire surface O_{F′} is treated in step (ii), the surface O_{F} of the resultant ASC F differs completely from O_{F′}, meaning that O_{F} and O_{FΔ} are identical.

Alternatively and preferably, in step (ii), it is also possible to treat just part of the surface O_{F′}. This is possible, for example, in that just a portion of the surface O_{F′} is sputtered, especially facing the plasma and hence the noble gas cations N and being sputtered thereby, and ASC is removed only in this part of the surface O_{F′}. In addition, a portion of the surface O_{F′} may also be covered with a template, such that just part of the surface O_{F′} is removed from the noble gas cations N⁺. In this case, an ASC F is obtained, the surface O_{F} of which is still partly identical to the surface O_{F′} of F and differs from O_{F′} in the portion O_{FΔ}.

In the embodiment of the present invention in which just a portion of the surface O_{F′} is treated in step (ii) and the surface O_{F} of the ASC F obtained does not differ completely, but differs only partly, from O_{F′}, the shape of O_{FΔ}, if O_{FΔ} is encompassed only at least partly by O_{A/MK} and/or O_{KK}, is subject to no further restriction. For example, O_{FΔ} may form a coherent subregion on the surface O_{F}. Alternatively, O_{FΔ} may be formed by multiple unconnected subregions on the surface O_{F}, such that the shape thereof is reminiscent of the shape of the black spots (which would correspond to O_{F}A) on the white coat (which would correspond to O_{F}) of the Dalmatian breed of dog.

It is preferable that the surface O_{F}‘ of the ASC F’ is treated in step (ii) such that the area O_{FΔ} formed by sputtering in the resulting ASC F comprises at least one of the surface portions O_{A/MK} and O_{KK}, and preferably comprises both. It is very particularly preferable that the part O_{FΔ} of the surface O_{F} formed by sputtering coincides with at least one of the parts O_{A/MK}, O_{KK} (O_{FΔ}=O_{A/MK} or O_{FΔ}=O_{KK}). It is even more preferable that the part O_{FΔ} of the surface O_{F} formed by sputtering coincides with both parts O_{A/MK}, O_{KK} (O_{FΔ}=O_{A/MK}+O_{KK}).

### 4.2.2 Increase in Mass-Based Specific Surface Area

The surprising advantage of the present invention is that step (ii) affords an ASC F having higher conductivity compared to the ASC F′ used in step (ii) when used in the electrolysis cell E according to step (iii) and step (iv-β).

More particularly, S_{MF′}<S_{MF}, where S_{MF′} is the mass-based specific surface area S_{M} of the alkali metal cation-conducting solid-state electrolyte ceramic F′ before performance of step (ii) and where S_{MF} is the mass-based specific surface area S_{M} of the alkali metal cation-conducting solid-state electrolyte ceramic F after performance of step (ii). This means that the mass-based specific surface area S_{M} of the ASC F′ subjected to step (ii) is increased during the performance of step (ii) from S_{MF′} to S_{MF} in the ASC F obtained.

The mass-based specific surface area S_{M} means the surface area A possessed by a material per unit mass m. (S_{M}=A/m, unit: m²/kg).

The comparison of the mass-based specific surface areas S_{MF′} and S_{MF}, i.e. the testing of the condition whether S_{MF′}<S_{MF}, can be determined by methods known to the person skilled in the art for measuring the BET (Brunauer-Emmett-Teller) surface area, by measuring both ASCs F and F′ under the same conditions. Even if the ratio of the two parameters S_{MF′} and S_{MF} is determined under different measurement conditions, the ratio S_{MF}/S_{MF′} measured under particular measurement conditions will essentially be the same as the ratio S_{MF}/S_{MF′} measured under different measurement conditions.

More particularly, in the context of the present invention, the mass-based specific surface areas are carried out via BET measurements to ISO 9277:2010 with N₂ (purity 99.99% by volume) as adsorbent at 77.35 K.

Instrument: Quantachrome NOVA 2200e, Quantachrome Instruments.

Sample preparation: degassing of the sample at 60° C. at 1 Pa. The evaluation is especially undertaken via the static volumetric method (according to point 6.3.1 of standard ISO 9277:2010).

In respect of the ratio of S_{MF′} and S_{MF}, i.e. the quotient S_{MF}/S_{MF′}, the following applies in a preferred embodiment of the present invention:

S_{MF}/S_{MF′}≥1.01, preferably S_{MF}/S_{MF′}≥1.1, preferably S_{MF}/S_{MF′}≥1.5, preferably S_{MF}/S_{MF′}≥2.0, preferably S_{MF}/S_{MF′}≥3.0, preferably S_{MF}/S_{MF′}≥5.0, preferably S_{MF}/S_{MF′}≥10, more preferably S_{MF}/S_{MF′}≥20, more preferably S_{MF}/S_{MF′}≥50, more preferably S_{MF}/S_{MF′}≥100, more preferably SMF/S_{MF′}≥150, more preferably SMF/S_{MF′}≥200, more preferably SMF/S_{MF′}≥500, more preferably SMF/S_{MF′}≥1000.

In another preferred embodiment of the present invention, the quotient S_{MF}/S_{MF′} is in the range from 1.01 to 1000, preferably in the range from 1.1 to 500, more preferably in the range from 1.5 to 200, more preferably in the range from 2.0 to 150, more preferably in the range from 3.0 to 50, more preferably in the range from 5.0 to 25, more preferably in the range from 15 to 25, more preferably in the range from 18 to 22.

### 4.3 Step (iii)

In step (iii) of the process according to the invention, the ASC F obtained in step (ii) is disposed in an electrolysis cell E.

### 4.3.1 Electrolysis Cell E

The electrolysis cell E comprises at least one anode chamber K_{A} and at least one cathode chamber K_{K}, and at least one interposed middle chamber K_{M}. This also includes electrolysis cells E having more than one anode chamber K_{A} and/or more than one cathode chamber K_{K} and/or more than one middle chamber K_{M}. Such electrolysis cells in which these chambers are joined to one another in the form of modules are described, for example, in DD 258 143 A3 and US 2006/0226022 A1.

The electrolysis cell E, in a preferred embodiment, comprises an anode chamber K_{A} and a cathode chamber K_{K}, and an interposed middle chamber K_{M}.

The electrolysis cell E typically has an outer wall W_{A}. The outer wall W_{A} is especially made from a material selected from the group consisting of steel, preferably rubberized steel, plastic, especially selected from Telene® (thermoset polydicyclopentadiene), PVC (polyvinylchloride), PVC-C (post-chlorinated polyvinylchloride), PVDF (polyvinylidenefluoride). W_{A} may especially be perforated for inlets and outlets. Within W_{A} are then the at least one anode chamber K_{A}, the at least one cathode chamber K_{K} and, in the embodiments in which the electrolysis cell E comprises one, the at least one interposed middle chamber K_{M}.

### 4.3.1.1 Cathode Chamber K_{K}

The cathode chamber K_{K} has at least one inlet Z_{KK}, at least one outlet A_{KK}, and an interior I_{KK} comprising a cathodic electrode E_{K}.

The interior I_{KK} of the cathode chamber K_{K} is divided from the interior I_{KM} of the middle chamber K_{M} by the dividing wall W.

The dividing wall W comprises the alkali metal cation-conducting solid-state electrolyte ceramic F, and F makes direct contact with the interior I_{KK} via the surface O_{KK} and with the interior I_{KM} via the surface OA/MK.

### 4.3.1.1.1 Dividing Wall W

The dividing wall W comprises the alkali metal cation-conducting solid-state electrolyte ceramic F. What is meant by the feature “dividing wall” is that the dividing wall W is liquid-tight. What this means more particularly is that the alkali metal cation-conducting solid-state electrolyte ceramic F encompassed by the dividing wall divides the interior I_{KK} and the interior I_{KM} completely from one another, or comprises multiple alkali metal cation-conducting solid-state electrolyte ceramics which join one another, for example in a gapless manner.

There at least exist no gaps in the dividing wall W through which aqueous solution, alcoholic solution, alcohol or water could flow from I_{KK} into I_{KM} or vice versa.

What is meant by “makes direct contact” in respect of the arrangement of the alkali metal cation-conducting solid-state electrolyte ceramics in the dividing wall W and in the electrolysis cell E and in respect of the surfaces O_{KK} and O_{A/MK} is that there is a theoretical pathway from I_{KK} into I_{KM} that leads completely from I_{KK} via O_{KK} through F to O_{A/MK} and ultimately into I_{KM}.

It is preferable that at least 1% of the surface O_{A/MK} is formed by O_{FΔ} and/or, especially and, at least 1% of the surface O_{KK} by O_{FΔ}.

Even more preferably, at least 10% of the surface O_{A/MK} is formed by O_{FΔ} and/or, especially and, at least 10% of the surface O_{KK} by O_{FΔ}.

Even more preferably, at least 25% of the surface O_{A/MK} is formed by O_{FΔ} and/or, especially and, at least 25% of the surface O_{KK} by O_{FΔ}.

Even more preferably, at least 40% of the surface O_{A/MK} is formed by O_{FΔ} and/or, especially and, at least 40% of the surface O_{KK} by O_{FΔ}.

Even more preferably, at least 50% of the surface O_{A/MK} is formed by O_{FΔ} and/or, especially and, at least 50% of the surface O_{KK} by O_{FΔ}.

Even more preferably, at least 60% of the surface O_{A/MK} is formed by O_{FΔ} and/or, especially and, at least 60% of the surface O_{KK} by O_{FΔ}.

Even more preferably, at least 70% of the surface O_{A/MK} is formed by O_{FΔ} and/or, especially and, at least 70% of the surface O_{KK} by O_{FΔ}.

Even more preferably, at least 80% of the surface O_{A/MK} is formed by O_{FΔ} and/or, especially and, at least 80% of the surface O_{KK} by O_{FΔ}.

Even more preferably, at least 90% of the surface O_{A/MK} is formed by O_{FΔ} and/or, especially and, at least 90% of the surface O_{KK} by O_{FΔ}.

Even more preferably, 100% of the surface O_{A/MK} is formed by O_{FΔ} and/or, especially and, 100% of the surface O_{KK} by O_{FΔ}.

This is advantageous since, as a result, the sputtered surface of F that takes part in the process according to the invention [step (iv-β)], i.e. through which the ion flow takes place in the electrolysis, is particularly large.

### 4.3.1.1.2 Cathodic Electrode E_{K}

The cathode chamber K_{K} comprises an interior I_{KK} which in turn comprises a cathodic electrode E_{K}. A useful cathodic electrode E_{K} of this kind is any electrode familiar to the person skilled in the art that is stable under the conditions of the process according to the invention. These are described, in particular, in WO 2014/008410 A1, paragraph [025] or DE 10360758 A1, paragraph [030]. This electrode E_{K} may be selected from the group consisting of mesh wool, three-dimensional matrix structure and “balls”. The cathodic electrode E_{K} especially comprises a material selected from the group consisting of steel, nickel, copper, platinum, platinized metals, palladium, carbon-supported palladium, titanium. Preferably, E_{K} comprises nickel.

4.3.1.1.3 Inlet Z_{KK} and Outlet A_{KK}

The cathode chamber K_{K} also encompasses an inlet Z_{KK} and an outlet A_{KK}. This enables addition of liquid, for example the solution L₂, to the interior I_{KK} of the cathode chamber K_{K}, and removal of liquid present therein, for example the solution L₁. The inlet Z_{KK} and the outlet A_{KK} are attached here to the cathode chamber K_{K} in such a way that the liquid comes into contact with the cathodic electrode E_{K} as it flows through the interior I_{KK} of the cathode chamber K_{K}. This is a prerequisite for the solution L₁ to be obtained at the outlet A_{KK} in the performance of the process according to the invention when the solution L₂ of an alkali metal alkoxide XOR in the alcohol ROH is routed through the interior I_{KK} of the cathode chamber K_{K}.

The inlet Z_{KK} and the outlet A_{KK} may be attached to the electrolysis cell E by methods known to the person skilled in the art, for example by means of holes in the outer wall W_{A} and corresponding connections (valves) that simplify the introduction and discharge of liquid.

### 4.3.1.2 Anode Chamber K_{A}

The anode chamber K_{A} has at least one inlet Z_{KA}, at least one outlet A_{KA}, and an interior I_{KA} comprising an anodic electrode E_{A}.

The interior I_{KA} of the anode chamber K_{A} is divided from the interior I_{KM} of the middle chamber K_{M} by a diffusion barrier D.

### 4.3.1.2.1 Anodic Electrode E_{A}

The anode chamber K_{A} comprises an interior I_{KA} which in turn comprises an anodic electrode E_{A}. A useful anodic electrode E_{A} of this kind is any electrode familiar to the person skilled in the art that is stable under the conditions of the process according to the invention. These are described, in particular, in WO 2014/008410 A1, paragraph [024] or DE 10360758 A1, paragraph [031]. This electrode E_{A} may consist of one layer or consist of multiple planar layers parallel to one another that may each be perforated or expanded. The anodic electrode E_{A} especially comprises a material selected from the group consisting of ruthenium oxide, iridium oxide, nickel, cobalt, nickel tungstate, nickel titanate, precious metals such as, in particular, platinum, supported on a support such as titanium or Kovar® (an iron/nickel/cobalt alloy in which the individual components are preferably as follows: 54% by mass of iron, 29% by mass of nickel, 17% by mass of cobalt). Further possible anode materials are especially stainless steel, lead, graphite, tungsten carbide, titanium diboride. Preferably, the anodic electrode E_{A} comprises a titanium anode coated with ruthenium oxide/iridium oxide (RuO₂+IrO₂/Ti).

4.3.1.2.2 Inlet Z_{KA} and Outlet A_{KA}

The anode chamber K_{A} also encompasses an inlet Z_{KA} and an outlet A_{KA}. This enables addition of liquid, for example the solution L₃, to the interior I_{KA} of the anode chamber K_{A}, and removal of liquid present therein, for example the solution L₄. The inlet Z_{KA} and the outlet A_{KA} are attached here to the anode chamber K_{A} in such a way that the liquid comes into contact with the anodic electrode E_{A} as it flows through the interior I_{KA} of the anode chamber K_{A}. This is a prerequisite for the solution L₄ to be obtained at the outlet A_{KA} in the performance of the process according to the invention when the solution L₃ of a salt S is routed through the interior I_{KA} of the anode chamber K_{A}.

The inlet Z_{KA} and the outlet A_{KA} may be attached to the electrolysis cell E by methods known to the person skilled in the art, for example by means of holes in the outer wall W_{A} and corresponding connections (valves) that simplify the introduction and discharge of liquid. The inlet Z_{KA}, in particular embodiments, may also be within the electrolysis cell, for example in the form of a perforation in the diffusion barrier D.

### 4.3.1.3 Middle Chamber K_{M}

The electrolysis cell E has at least one middle chamber K_{M}. The middle chamber K_{M} lies between cathode chamber K_{K} and anode chamber K_{A}.

The interior I_{KA} of the anode chamber K_{A} is divided from the interior I_{KM} of the middle chamber K_{M} by a diffusion barrier D. A_{KM} is then also connected to the inlet Z_{KA} by a connection V_{AM}, such that liquid can be guided from I_{KM} into I_{KA} through the connection V_{AM}.

### 4.3.1.3.1 Diffusion Barrier D

The interior I_{KM} of the middle chamber K_{M} is divided from the interior I_{KA} of the anode chamber K_{A} by a diffusion barrier D and divided from the interior I_{KK} of the cathode chamber K_{K} by the dividing wall W.

The material used for the diffusion barrier D may be any which is stable under the conditions of the process according to the invention and prevents or slows the transfer of protons from the liquid present in the interior I_{K}a of the anode chamber K_{A} to the interior I_{KM} of the middle chamber K_{M}. The diffusion barrier D used is especially a non-ion-specific dividing wall or a membrane permeable to specific ions. The diffusion barrier D is preferably a non-ion-specific dividing wall.

The material of the non-ion-specific dividing wall is especially selected from the group consisting of fabric, which is especially textile fabric or metal weave, glass, which is especially sintered glass or glass frits, ceramic, especially ceramic frits, membrane diaphragms, and is more preferably a textile fabric or metal weave, especially preferably a textile fabric. The textile fabric preferably comprises plastic, more preferably a plastic selected from PVC, PVC-C, polyvinylether (“PVE”), polytetrafluoroethylene (“PTFE”).

If the diffusion barrier D is a “membrane permeable to specific ions”, what this means in accordance with the invention is that the respective membrane promotes the diffusion of particular ions therethrough over other ions. More particularly, what this means is membranes that promote the diffusion therethrough of ions of a particular charge type over ions of the opposite charge. Even more preferably, membranes permeable to specific ions also promote the diffusion of particular ions of one charge type over other ions of the same charge type therethrough.

If the diffusion barrier D is a “membrane permeable to specific ions”, the diffusion barrier D is especially an anion-conducting membrane or a cation-conducting membrane.

According to the invention, anion-conducting membranes are those that selectively conduct anions, preferably selectively conduct particular anions. In other words, they promote the diffusion of anions therethrough over that of cations, especially over protons; even more preferably, they additionally promote the diffusion of particular anions therethrough over the diffusion of other anions therethrough.

According to the invention, cation-conducting membranes are those that selectively conduct cations, preferably selectively conduct particular cations. In other words, they promote the diffusion of cations therethrough over that of anions; even more preferably, they additionally promote the diffusion of particular cations therethrough over the diffusion of other cations therethrough, more preferably still that of cations that are not protons, more preferably sodium cations, over protons.

What is meant more particularly by “promote the diffusion of particular ions X over the diffusion of other ions Y” is that the coefficient of diffusion (unit: m²/s) of ion type X at a given temperature for the membrane in question is higher by a factor of 10, preferably 100, preferably 1000, than the coefficient of diffusion of ion type Y for the membrane in question.

If the diffusion barrier D is a “membrane permeable to specific ions”, it is preferably an anion-conducting membrane since this particularly efficiently prevents the diffusion of protons from the anode chamber K_{A} into the middle chamber K_{M}.

The anion-conducting membrane used is especially one selective for the anions encompassed by the salt S. Such membranes are known to and can be used by the person skilled in the art.

The salt S is preferably a halide, sulfate, sulfite, nitrate, hydrogencarbonate or carbonate of X, even more preferably a halide.

Halides are fluorides, chlorides, bromides, iodides. The most preferred halide is chloride.

The anion-conducting membrane used is preferably one selective for halides, preferably chloride.

Anion-conducting membranes are described, for example, by M. A. Hickner, A. M. Herring, E. B. Coughlin, Journal of Polymer Science, Part B: Polymer Physics 2013, 51, 1727-1735, by C. G. Arges, V. Ramani, P. N. Pintauro, Electrochemical Society Interface 2010, 19, 31-35, in WO 2007/048712 A2, and on page 181 of the textbook by Volkmar M. Schmidt, Elektrochemische Verfahrenstechnik: Grundlagen, Reaktionstechnik, Prozessoptimierung [Electrochemical Engineering: Fundamentals, Reaction Technology, Process Optimization], 1st edition (8 Oct. 2003).

Even more preferably, anion-conducting membranes used are accordingly organic polymers that are especially selected from polyethylene, polybenzimidazoles, polyether ketones, polystyrene, polypropylene and fluorinated membranes such as polyperfluoroethylene, preferably polystyrene, where these have covalently bonded functional groups selected from —NH₃⁺, —NRH₂⁺, —NR₃⁺, =NR⁺; —PR₃⁺, where R is alkyl groups having preferably 1 to 20 carbon atoms, or other cationic groups. They preferably have covalently bonded functional groups selected from —NH₃⁺, —NRH₂⁺ and —NR₃⁺, more preferably selected from —NH₃⁺ and —NR₃⁺, even more preferably —NR₃⁺.

If the diffusion barrier D is a cation-conducting membrane, it is especially a membrane selective for the cations encompassed by the salt S. Even more preferably, the diffusion barrier D is an alkali metal cation-conducting membrane, even more preferably a potassium and/or sodium ion-conducting membrane, most preferably a sodium ion-conducting membrane.

Cation-conducting membranes are described, for example, on page 181 of the textbook by Volkmar M. Schmidt, Elektrochemische Verfahrenstechnik: Grundlagen, Reaktionstechnik, Prozessoptimierung, 1st edition (Oct. 8, 2003).

Even more preferably, cation-conducting membranes used are accordingly organic polymers that are especially selected from polyethylene, polybenzimidazoles, polyether ketones, polystyrene, polypropylene and fluorinated membranes such as polyperfluoroethylene, preferably polystyrene and polyperfluoroethylene, where these bear covalently bonded functional groups selected from —SO₃⁻, —COO⁻, —PO₃²⁻ and —PO₂H⁻, preferably —SO₃⁻ (described in DE 10 2010 062 804 A1, U.S. Pat. No. 4,831,146).

This may be, for example, a sulfonated polyperfluoroethylene (Nafion® with CAS number: 31175-20-9). These are known to the person skilled in the art, for example from WO 2008/076327 A1, paragraph [058], US 2010/0044242 A1, paragraph [0042] or US 2016/0204459 A1, and are commercially available under the Nafion®, Aciplex® F, Flemion®, Neosepta®, Ultrex®, PC—SK® trade names. Neosepta® membranes are described, for example, by S. A. Mareev, D. Yu. Butylskii, N. D. Pismenskaya, C. Larchet, L. Dammak, V. V. Nikonenko, Journal of Membrane Science 2018, 563, 768-776.

If a cation-conducting membrane is used as diffusion barrier D, this may, for example, be a polymer functionalized with sulfonic acid groups, especially of the formula P_{NAFION} below, where n and m may independently be a whole number from 1 to 10⁶, preferably a whole number from 10 to 10⁵, more preferably a whole number from 10² to 104.

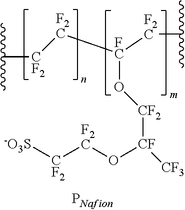

4.3.1.3.2 Inlet Z_{KM} and Outlet A_{KM}

The middle chamber K_{M} also encompasses an inlet Z_{KM} and an outlet A_{KM}. This enables addition of liquid, for example the solution L₃, to the interior I_{KM} of the middle chamber K_{M}, and transfer of liquid present therein, for example the solution L₃, to the anode chamber K_{A}.

The inlet Z_{KM} and the outlet A_{KM} may be attached to the electrolysis cell E by methods known to the person skilled in the art, for example by means of holes in the outer wall W_{A} and corresponding connections (valves) that simplify the introduction and discharge of liquid. The outlet A_{KM} may also be within the electrolysis cell, for example in the form of a perforation in the diffusion barrier D.

### 4.3.1.3.3 Connection V_{AM}

In the electrolysis cell E, the outlet A_{KM} is connected to the inlet Z_{KA} by a connection V_{AM} in such a way that liquid can be guided from I_{KM} into I_{KA} through the connection V_{AM}.

The connection V_{AM} may be formed within the electrolysis cell E and/or outside the electrolysis cell E, and is preferably formed within the electrolysis cell.

1) If the connection V_{AM} is formed within the electrolysis cell E, it is preferably formed by at least one perforation in the diffusion barrier D. This embodiment is preferred especially when the diffusion barrier D used is a non-ion-specific dividing wall, especially a metal weave or textile fabric. This functions as a diffusion barrier D and, on account of the weave properties, has perforations and gaps from the outset that function as connection V_{AM}.

2) The embodiment described hereinafter is preferred especially when the diffusion barrier D used is a membrane permeable to specific ions: In this embodiment, the connection V_{AM} is formed outside the electrolysis cell E, preferably formed by a connection of A_{KM} and Z_{KA} that runs outside the electrolysis cell E, especially in that an outlet A_{KM} is formed from the interior of the middle chamber I_{KM}, preferably at the base of the middle chamber K_{M}, the inlet Z_{KM} more preferably being at the top end O_{EM} of the middle chamber K_{M}, and an inlet Z_{KA} is formed in the interior I_{KA} of the anode chamber K_{A}, preferably at the base of the anode chamber K_{A}, and these are connected by a conduit, for example a pipe or a hose, preferably comprising a material selected from rubber and plastic. This is advantageous especially since the outlet A_{KA}, according to the invention, is formed at the top end O_{EA} of the anode chamber K_{A}.

What is more particularly meant by “outlet A_{KM} at the base of the middle chamber K_{M}” is that the outlet A_{KM} is attached to the electrolysis cell E in such a way that the solution L₃ leaves the middle chamber K_{M} in the direction of gravity.

What is more particularly meant by “inlet Z_{KA} at the base of the anode chamber K_{A}” is that the inlet Z_{KA} is attached to the electrolysis cell E in such a way that the solution L₃ enters the anode chamber K_{A} counter to gravity.

What is more particularly meant by “inlet Z_{KM} at the top end O_{EM} of the middle chamber K_{M}” is that the inlet Z_{KM} is attached to the electrolysis cell E in such a way that the solution L₃ enters the middle chamber K_{M} in the direction of gravity.

What is more particularly meant by “outlet A_{KA} at the top end O_{EA} of the anode chamber K_{A}” is that the outlet A_{KA} is attached to the electrolysis cell E in such a way that the solution L₄ leaves the anode chamber K_{A} counter to gravity.

This embodiment is particularly advantageous and therefore preferred when the outlet A_{KM} is formed by the base of the middle chamber K_{M}, and the inlet Z_{KA} by the base of the anode chamber K_{A}. This arrangement makes it possible in a particularly simple manner to remove gases formed in the anode chamber K_{A} from the anode chamber K_{A} with L₄, in order to then separate them further.

When the connection V_{AM} is formed outside the electrolysis cell E, Z_{KM} and A_{KM} are especially arranged at opposite ends of the outer wall W_{A} of the middle chamber K_{M} (i.e., for example, Z_{KM} at the base and A_{KM} at the top end O_{EM} of the electrolysis cell E or vice versa) and Z_{KA} and A_{KA} are arranged at opposite ends of the outer wall W_{A} of the anode chamber K_{A} (i.e. Z_{KA} at the base and A_{KA} at the top end O_{EA} of the electrolysis cell E), as shown more particularly in FIG. 3A. By virtue of this geometry, L₃ must flow through the two chambers K_{M} and K_{A}. It is possible here for Z_{KA} and Z_{KM} to be formed on the same side of the electrolysis cell E, in which case A_{KM} and A_{KA} are automatically also formed on the same side of the electrolysis cell E. Alternatively, Z_{KA} and Z_{KM} may be formed on opposite sides of the electrolysis cell E, in which case A_{KM} and A_{KA} are then automatically also formed on opposite sides of the electrolysis cell E.

3) When the connection V_{AM} is formed within the electrolysis cell E, this may especially be implemented in that one side (“side A”) of the electrolysis cell E, which is the top end O_{E}, comprises the inlet Z_{KM} and the outlet A_{KA}, and the diffusion barrier D extends proceeding from this side (“side A”) into the electrolysis cell E, but does not quite reach up to the opposite side (“side B”) of the electrolysis cell E from side A, which is then the base of the electrolysis cell E, and at the same time covers 50% or more of the height of the three-chamber cell E, preferably 60% to 99% of the height of the three-chamber cell E, more preferably 70% to 95% of the height of the three-chamber cell E, even more preferably 80% to 90% of the height of the three-chamber cell E, more preferably still 85% of the height of the three-chamber cell E. Because the diffusion barrier D does not touch side B of the three-chamber cell E, a gap thus arises between diffusion barrier D and the vessel B_{E} on side B of the three-chamber cell E. In that case, the gap is the connection V_{AM}. By virtue of this geometry, L₃ must flow completely through the two chambers K_{M} and K_{A}.

These embodiments best assure that the aqueous salt solution L₃ flows past the acid-sensitive solid-state electrolyte before it comes into contact with the anodic electrode E_{A}, which results in the formation of acids.

According to the invention, “base of the electrolysis cell E” is the side of the electrolysis cell E through which a solution (e.g. L₃ in the case of A_{KM} in FIG. 3A) exits from the electrolysis cell E in the same direction as gravity, or the side of the electrolysis cell E through which a solution (e.g. L₂ in the case of Z_{KK} in FIGS. 2A, 3A and 3B and L₃ in the case of A_{KA} in FIGS. 2A, 2B and 3A) is supplied to the electrolysis cell E counter to gravity.

According to the invention, “top end O_{E} of the electrolysis cell E” is the end of the electrolysis cell E through which a solution (e.g. L₄ in the case of A_{KA} and L₁ in the case of A_{KK} in all figures) exits from the electrolysis cell E counter to gravity, or the end of the electrolysis cell E through which a solution (e.g. L₃ in the case of Z_{KM} in FIGS. 3A and 3B) is supplied to the electrolysis cell E in the same direction as gravity.

### 4.3.1.4 Arrangement of the Dividing Wall W in the Electrolysis Cell E

The dividing wall W is arranged in the electrolysis cell E such that the alkali metal cation-conducting solid-state electrolyte ceramic F encompassed by the dividing wall W makes direct contact with the interior I_{KK} via the surface O_{KK}.

This means that the dividing wall W is arranged in the electrolysis cell E such that, when the interior I_{KK} is completely filled with solution L₂, the solution L₂ contacts (i.e. wets) the surface O_{KK} of the alkali metal cation-conducting solid-state electrolyte ceramic F encompassed by the dividing wall W, such that ions (e.g. alkali metal ions such as sodium, lithium) can enter the solution L₂ from the alkali metal cation-conducting solid-state electrolyte ceramic F encompassed by the dividing wall W via the surface O_{KK}.

In addition, the dividing wall W is arranged in the electrolysis cell E such that the alkali metal cation-conducting solid-state electrolyte ceramic F encompassed by the dividing wall W makes direct contact with the interior I_{KM} via the surface O_{A/MK}.

What this means is as follows: the electrolysis cell E comprises at least one middle chamber K_{M}, and the dividing wall W adjoins the interior I_{KM} of the middle chamber K_{M}.

The dividing wall W is arranged in the electrolysis cell E such that, when the interior I_{KM} is completely filled with solution L₃, the solution L₃ contacts (i.e. wets) the surface O_{A/MK} of the alkali metal cation-conducting solid-state electrolyte ceramic F encompassed by the dividing wall W, such that ions (e.g. alkali metal ions such as sodium, lithium) from the solution L₃ can enter the alkali metal cation-conducting solid-state electrolyte ceramic F encompassed by the dividing wall W via the surface OA/MK.

### 4.4 Process Steps According to the Invention

The present invention relates to a process for producing a solution L₁ of an alkali metal alkoxide XOR in the alcohol ROH, where X is an alkali metal cation and R is an alkyl radical having 1 to 4 carbon atoms. The process is conducted in an electrolysis cell E.

X is preferably selected from the group consisting of Li⁺, K⁺, Na⁺, more preferably from the group consisting of K⁺, Na⁺. Most preferably, X=Na⁺.

R is preferably selected from the group consisting of n-propyl, iso-propyl, ethyl and methyl, more preferably from the group consisting of ethyl and methyl. R is most preferably methyl.

The steps (β1), (β2), (β3) that proceed simultaneously are conducted.

### 4.4.1 Step (β1)

In step (β1), a solution L₂ comprising the alcohol ROH, preferably comprising an alkali metal alkoxide XOR and alcohol ROH, is routed through I_{KK}. In the cases in which O_{KK} encompasses at least a portion of O_{FΔ}, the solution L₂ makes direct contact here with the surface O_{FΔ}. More particularly, the solution L₂ then makes direct contact with the entire surface O_{FΔ} encompassed by O_{KK}.

This means that, in the cases in which O_{KK} encompasses the entire surface O_{FΔ}, L₂ makes direct contact with at least part of the surface O_{FΔ}, and, in the cases in which O_{KK} encompasses only part of the surface O_{FΔ}, L₂ makes direct contact with at least part of the surface O_{FΔ} encompassed by O_{KK}.

This preferably means that, in the cases in which O_{KK} encompasses the entire surface O_{FΔ}, L₂ makes direct contact with the whole surface O_{FΔ}, and, in the cases in which O_{KK} encompasses only part of the surface O_{FΔ}, L₂ makes direct contact with the whole part of the surface O_{F}A encompassed by O_{KK}.

Solution L₂ is preferably free of water. What is meant in accordance with the invention by “free of water” is that the weight of water in solution L₂ based on the weight of the alcohol ROH in solution L₂ (mass ratio) is ≤1:10, more preferably ≤1:20, even more preferably ≤1:100, even more preferably ≤0.5:100.

If solution L₂ comprises XOR, the proportion by mass of XOR in solution L₂, based on the overall solution L₂, is especially >0% to 30% by weight, preferably 5% to 20% by weight, more preferably 10% to 20% by weight, more preferably 10% to 15% by weight, most preferably 13% to 14% by weight, at the very most preferably 13% by weight.

If solution L₂ comprises XOR, the mass ratio of XOR to alcohol ROH in solution L₂ is especially in the range of 1:100 to 1:5, more preferably in the range of 1:25 to 3:20, even more preferably in the range of 1:12 to 1:8, even more preferably 1:10.

### 4.4.2 Step (β2)

In step (β2), a neutral or alkaline aqueous solution L₃ of a salt S comprising X as cation is routed through I_{KM}, then via V_{AM}, then through I_{KA}. In the cases in which O_{A/MK} encompasses at least a portion of O_{FΔ}, the solution L₃ makes direct contact here with the surface O_{FΔ}. More particularly, the solution L₃ then makes direct contact with the entire surface O_{FΔ} encompassed by O_{A/MK}.

This means that, in the cases in which O_{A/MK} encompasses the entire surface O_{FΔ}, L₃ makes direct contact with at least part of the surface O_{FΔ}, and, in the cases in which O_{A/MK} encompasses only part of the surface O_{FΔ}, L₃ makes direct contact with at least part of the surface O_{FΔ} encompassed by OA/MK.

This preferably means that, in the cases in which O_{A/MK} encompasses the entire surface O_{FΔ}, L₃ makes direct contact with the whole surface O_{FΔ}, and, in the cases in which O_{A/MK} encompasses only part of the surface O_{FΔ}, L₃ makes direct contact with the whole part of the surface O_{FΔ} encompassed by OA/MK.

The salt S is preferably a halide, sulfate, sulfite, nitrate, hydrogencarbonate or carbonate of X, even more preferably a halide.

Halides are fluorides, chlorides, bromides, iodides. The most preferred halide is chloride.

The pH of the aqueous solution L₃ is ≥7.0, preferably in the range of 7 to 12, more preferably in the range of 8 to 11, even more preferably 10 to 11, most preferably 10.5.

The proportion by mass of salt S in solution L₃ is preferably in the range of >0% to 20% by weight, preferably 1% to 20% by weight, more preferably 5% to 20% by weight, even more preferably 10% to 20% by weight, most preferably 20% by weight, based on the overall solution L₃.

### 4.4.3 Step (β3)

In step (β3), a voltage is then applied between E_{A} and E_{K}.

This results in transfer of current from the charge source to the anode, transfer of charge via ions to the cathode and ultimately transfer of current back to the charge source. The charge source is known to the person skilled in the art and is typically a rectifier that converts alternating current to direct current and can generate particular voltages via voltage transformers.

This in turn has the following consequences:
the solution L₁ is obtained at the outlet A_{KK} with a higher concentration of XOR in L₁ than in L₂,
an aqueous solution L₄ of S is obtained at the outlet A_{KA}, with a lower concentration of S in L₄ than in L₃.

In step (β3) of the process, in particular, such a voltage is applied that such a current flows that the current density (=ratio of the current supplied to the electrolysis cell to the area of the solid-state electrolyte in contact with the anolyte present in the interior I_{KM}) is in the range from 10 to 8000 A/m², more preferably in the range from 100 to 2000 A/m², even more preferably in the range from 300 to 800 A/m², and even more preferably is 494 A/m². This can be determined in a standard manner by the person skilled in the art. The area of the solid-state electrolyte in contact with the anolyte present in the interior I_{KM} of the middle chamber K_{M} is especially 0.00001 to 10 m², preferably 0.0001 to 2.5 m², more preferably 0.0002 to 0.15 m², even more preferably 2.83 cm².

It is preferable that both O_{A/MK} and O_{KK} encompass part of the surface O_{FΔ}. Step (β3) of the process is more preferably performed when the interior I_{KM} is laden with L₃ and the interior I_{KK} with L₂ at least to such an extent that L₃ and L₂ make direct contact with the surface O_{FΔ} of the alkali metal cation-conducting solid-state electrolyte ceramic F encompassed by the dividing wall W. This is preferable since, as a result, the surface O_{FΔ} obtained as a result of the treatment in step (ii) within the two surfaces O_{A/MK} and O_{KK} takes part in the electrolysis process, and the advantageous properties of the alkali metal cation-conducting solid-state electrolyte ceramic F, which are manifested in an increase in conductivity and hence an increase in current density at the same voltage, have a particularly positive effect.

The fact that transfer of charge takes place between E_{A} and E_{K} in step (β3) implies that I_{KK}, I_{KM} and I_{KA} are simultaneously laden with L₂ and L₃ respectively such that they cover the electrodes E_{A} and E_{K} to such an extent that the circuit is complete.

This is the case especially when a liquid stream of L₃ is routed continuously through I_{KM}, V_{AM} and I_{KA} and a liquid stream of L₂ through I_{KK}, and the liquid stream of L₃ covers electrode E_{A} and the liquid stream of L₂ covers electrode E_{K} at least partly, preferably completely.

In a further preferred embodiment, the process is performed continuously, i.e. step (β1) and step (β2) are performed continuously, while applying voltage as per step (β3).

After performance of step (β3), solution L₁ is obtained at the outlet A_{KK}, wherein the concentration of XOR in L₁ is higher than in L₂. If L₂ already comprised XOR, the concentration of XOR in L₁ is preferably 1.01 to 2.2 times, more preferably 1.04 to 1.8 times, even more preferably 1.077 to 1.4 times, even more preferably 1.077 to 1.08 times, higher than in L₂, most preferably 1.077 times higher than in L₂, where the proportion by mass of XOR in L₁ and in L₂ is more preferably in the range from 10% to 20% by weight, even more preferably 13% to 14% by weight.

An aqueous solution L₄ of S is obtained at the outlet A_{KA}, with a lower concentration of S in L₄ than in L₃.

The concentration of the cation X in the aqueous solution L₃ is preferably in the range of 3.5 to 5 mol/1, more preferably 4 mol/1. The concentration of the cation X in the aqueous solution L₄ is more preferably 0.5 mol/1 lower than that of the aqueous solution L₃ used in each case.

More particularly, steps (β1) to (β3) of the process are conducted at a temperature of 20° C. to 70° C., preferably 35° C. to 65° C., more preferably 35° C. to 60° C., even more preferably 35° C. to 50° C., and at a pressure of 0.5 bar to 1.5 bar, preferably 0.9 bar to 1.1 bar, more preferably 1.0 bar.

In the course of performance of steps (β1) to (β3) of the process, hydrogen is typically formed in the interior I_{KK} of cathode chamber K_{K}, which can be removed from the cell together with solution L₁ via the outlet A_{KK}. The mixture of hydrogen and solution L₁ can then, in a particular embodiment of the present invention, be separated by methods known to the person skilled in the art. When the alkali metal compound used is a halide, especially chloride, it is possible for chlorine or another halogen gas to form in the interior I_{KA} of the anode chamber K_{A}, and this can be removed from the cell together with solution L₄ via outlet A_{KK}. In addition, it is also possible for oxygen or/and carbon dioxide to form, which can likewise be removed. The mixture of chlorine, oxygen and/or CO₂ and solution L₄ can then, in a particular embodiment of the present invention, be separated by methods known to the person skilled in the art. It is then likewise possible, after the chlorine, oxygen and/or CO₂ gases have been separated from solution L₄, to separate these from one another by methods known to the person skilled in the art.

### 4.4.4 Additional Advantages of Steps (β1) to (β3)

This performance of steps (β1) to (β3) brings further surprising advantages that were not to be expected in the light of the prior art. Steps (β1) to (β3) of the process according to the invention protect the acid-labile solid-state electrolyte from corrosion without, as in the prior art, having to sacrifice alkoxide solution from the cathode space as buffer solution. Thus, these process steps are more efficient than the procedure described in WO 2008/076327 A1, in which the product solution is used for the middle chamber, which reduces the overall conversion.

### 5. EXAMPLES

### 5.1 Comparative Example 1

Sodium methoxide (SM) was produced via a cathodic process, with supply of 20% by weight NaCl solution (in water) in the anode chamber and of 10% by weight methanolic SM solution in the cathode chamber. This electrolysis cell consisted of three chambers, as shown in FIG. 3A.

The connection between middle chamber and anode chamber was established by a hose mounted at the base of the electrolysis cell. The anode chamber and middle chamber were separated by a 33 cm² cation exchange membrane (Asahi Kasei, sulfonic acid groups on polymer). Cathode chamber and middle chamber were separated by a ceramic of the NaSICON type with an area of 33 cm². The ceramic had a chemical composition of the formula Na_{3.4}Zr_{2.0}Si_{2.4}P_{0.6}O₁₂.

The NaSICON ceramic used in Comparative Example 1, before being disposed within the cell, was cut with a further ceramic of equal dimensions from the same block.

The anolyte was transferred through the middle chamber into the anode chamber. The flow rate of the anolyte was 1 l/h, and that of the catholyte 1 l/h. The temperature was 60° C.

The voltage was varied within a range from 0 to 8 V while recording the current.

It was also observed that a pH gradient developed in the middle chamber over a prolonged period, which is attributable to the migration of the ions to the electrodes in the course of the electrolysis and the spread of the protons formed in further reactions at the anode. This local increase in pH is undesirable since it can attack the solid-state electrolyte and can lead to corrosion and fracture of the solid-state electrolyte specifically in the case of very long periods of operation.

### 5.2 Comparative Example 2

Comparative Example 1 is repeated with a two-chamber cell comprising just one anode chamber and one cathode chamber, with the anode chamber having been separated from the cathode chamber by the ceramic of the NaSICON type. The arrangement corresponds to that shown in FIG. 2A. This electrolysis cell thus does not contain any middle chamber.

This is reflected in even faster corrosion of the ceramic compared to Comparative Example 1, which leads to a more rapid rise in the voltage curve when the electrolysis is to be conducted at constant current over a defined period of time.

### 5.3 Inventive Example 1

Comparative Example 1 is repeated.

For this purpose, the other NaSICON ceramic that is cut from the same block as that used in Comparative Example 1 is subjected to a sputtering process as follows:
The NaSICON ceramic is first introduced into the vacuum chamber of the sputtering device as target in front of the cathode. Subsequently, the pressure in the chamber is lowered to 10⁻⁶ mbar with the aid of a combination of rotation pump and turbo pump, and a gentle feed stream of argon is established such that the pressure in the chamber is 10⁻² mbar. For generation of the plasma, an AC voltage of 2 kV is applied between anode and cathode. The frequency of the AC voltage is 13.56 MHz, in order to lower the resistance of the nonconductive ceramic to such an extent that a plasma can form. At the same time, at this frequency, the electrons can still follow the applied field, but ions have too much inertia to follow the rapidly alternating field. The Ar⁺ ions formed in the plasma are accelerated in the direction of the cathode by the electrical field, where they meet the NaSICON ceramic and knock out individual constituents from the surface. The sputtering current is 40 mA.

This increases the mass-based specific surface area of the NaSICON ceramic by a factor of ˜20.

Thereafter, the electrolysis process according to Comparative Example 1 is repeated, with the surfaces that form on the ceramic in contact with the interiors of the cathode chamber and middle chamber.

It is found that a significantly lower voltage had to be applied over the duration of the electrolysis at the same current as in Comparative Example 1.

### 5.4 Comparative Example 3

Comparative Example 2 is repeated using an electrolysis cell in which the solid-state electrolyte ceramic treated according to Inventive Example 1 is used. Here too, a significant reduction in voltage compared to Comparative Example 2 is necessary at the same current.

### 5.5 Result

The pretreatment (sputtering) of the NaSICON ceramic and the exposure of the sputtered surfaces in the interiors of the anode chamber or middle chamber and the cathode chamber surprisingly increases the conductivity of the solid-state electrolyte.

The use of the three-chamber cell in the process according to the invention also prevents the corrosion of the solid-state electrolyte, and at the same time there is no need to sacrifice alkali metal alkoxide product for the middle chamber and the voltage is kept constant. These advantages that are already apparent from the comparison of the two Comparative Examples 1 and 2 underline the surprising effect of the use of the electrolysis cell comprising at least one middle chamber in the process according to the invention.

### 6. REFERENCE SYMBOLS IN THE FIGURES

| | | Reference symbols |
|---|---|---|
| Component | Abbreviation | in figures |
| Electrolysis cell | E | <1> |
| Anode chamber | K_{A} | <11> |
| Inlet | Z_{KA} | <110> |
| Outlet | A_{KA} | <111> |
| Interior | I_{KA} | <112> |
| Anodic electrode | E_{A} | <113> |
| Cathode chamber | K_{K} | <12> |
| Inlet | Z_{KK} | <120> |
| Outlet | A_{KK} | <121> |
| Interior | I_{KK} | <122> |
| Cathodic electrode | E_{K} | <123> |
| Middle chamber | K_{M} | <13> |
| Inlet | Z_{KM} | <130> |
| Outlet | A_{KM} | <131> |
| Interior | I_{KM} | <132> |
| Diffusion barrier | D | <14> |
| Connection | V_{AM} | <15> |
| Dividing wall | W | <16> |
| Solid-state electrolyte ceramic after step (ii) | F | <18> |
| Dust particles of the solid-state electrolyte ceramic F | | <185> |
| Surface of F | O_{F} | <180> |
| Subregion of O_{F} which, in the electrolysis cell E, | O_{A/MK} | <181> |
| makes direct contact with the interior I_{KM} of the | | |
| middle chamber K_{M} | | |
| Subregion of O_{F} which, in the electrolysis cell E, | O_{KK} | <182> |
| makes direct contact with the interior I_{KK} of the | | |
| cathode chamber K_{K} | | |
| Subregion of O_{F} which forms as a result of sputtering | O_{FΔ} | <183> |
| in step (ii) of the process according to the invention; | | |
| this subregion distinguishes O_{F} from O_{F′} | | |
| Solid-state electrolyte ceramic before step (ii) | F′ | <19> |
| Surface of F′ | O_{F′} | <190> |
| Subregion of O_{F′} | | <191> |
| Subregion of O_{F′} | | <192> |
| Alkali metal alkoxide XOR in the alcohol ROH | L₁ | <21> |
| Solution comprising the alcohol ROH | L₂ | <22> |
| Neutral or alkaline, aqueous solution of a salt S | L₃ | <23> |
| comprising X as cation | | |
| Aqueous solution of S, where [S]_{L4} < [S]_{L3}. | L₄ | <24> |
| Noble gas cations | N⁺ | <30> |
| Substrate film (e.g. titanium) | | <40> |
| Outer wall | W_{A} | <80> |
| Process chamber for sputtering | | <90> |

1-15. (canceled)

16. A process for producing a solution L₁ <21> of an alkali metal alkoxide XOR in an alcohol ROH, in an electrolysis cell E <1>, where X is an alkali metal cation and R is an alkyl radical having 1 to 4 carbon atoms, said process comprising the following steps:
(i) providing an alkali metal cation-conducting solid-state electrolyte ceramic, F′ <19>, having a surface O_{F′} <190>;
(ii) removing a portion of the alkali metal cation-conducting solid-state electrolyte ceramic F′ <19> by sputtering with noble gas cations N⁺ <30>, which produces an alkali metal cation-conducting solid-state electrolyte ceramic F <18> having a surface O_{F} <180> which differs from surface O_{F′} <190> in at least one subregion O_{FΔ} <183>, wherein: the surface O_{F}<180> comprises the surfaces O_{A/MK}<181> and O_{KK} <182>, and wherein O_{A/MK}<181> and/or O_{KK} <182> comprise at least a portion of O_{FΔ} <183>;
(iii) arranging the alkali metal cation-conducting solid-state electrolyte ceramic F <18> in an electrolysis cell E <1> comprising at least one anode chamber K_{A} <11>, at least one cathode chamber K_{K} <12> and at least one interposed middle chamber K_{M}<13>;
wherein the at least one anode chamber K_{A} <11> comprises:
at least one inlet Z_{KA} <110>;
at least one outlet A_{KA} <111>;
and an interior I_{KA} <112> with an anodic electrode E_{A} <113>;
the at least one cathode chamber K_{K} <12> comprises:
at least one inlet Z_{KK} <120>;
at least one outlet A_{KK} <121>;
and an interior I_{KK} <122> with a cathodic electrode E_{K} <123>;
and the at least one middle chamber K_{M}<13> comprises:
at least one inlet Z_{KM} <130>;
at least one outlet A_{KM} <131>;
and an interior I_{KM} <132>;
wherein I_{KA} <112> and I_{KM} <132> are divided from one another by a diffusion barrier D <14>, and A_{KM} <131> is connected by a connection V_{AM} <15> to the inlet Z_{KA} <110>, such that liquid can be passed from I_{KM} <132> into I_{KA} <112> via the connection V_{AM} <15>;
and I_{KK} <122> and I_{KM} <132> are divided from one another by a dividing wall W <16> comprising the alkali metal cation-conducting solid-state electrolyte ceramic F <18>, wherein F <18> makes direct contact with the interior I_{KK} <122> via the surface O_{KK} <182> and with the interior I_{KM} <132> via the surface O_{A/MK}<181>;
(iv-β) and wherein the following steps (β1), (β2), (β3) proceed simultaneously:
(β1) a solution L₂ <22> comprising the alcohol ROH is routed through I_{KK} <122>, wherein when O_{KK} <182> includes at least a portion of O_{FΔ} <183>, and the solution L₂ <22> makes direct contact with the surface O_{FΔ} <183>;
(β2) a neutral or alkaline, aqueous solution L₃ <23> of a salt S comprising X as cation is routed through I_{KM} <132>, then via V_{AM} <15> through I_{KA} <112>, where, when O_{A/MK}<181> includes at least a portion of O_{FΔ} <183>, and the solution L₃ <23> makes direct contact with surface O_{FΔ} <183>;
(β3) voltage is applied between E_{A} <113> and E_{K} <123>;
thereby providing solution L₁ <21> at the outlet A_{KK} <121>, with a higher concentration of XOR than in L₂ <22> and providing aqueous solution L₄ <24> at the outlet A_{KA} <111>, with a lower concentration of S than in L₃ <23>.

17. The process of claim 16, wherein: S_{MF′}<S_{MF}; and wherein S_{MF′} is the mass-based specific surface area S_{M} of the alkali metal cation-conducting solid-state electrolyte ceramic F′ before performance of step (ii) and S_{MF} is the mass-based specific surface area S_{M} of the alkali metal cation-conducting solid-state electrolyte ceramic F after performance of step (ii).

18. The process of claim 17, wherein the quotient S_{MF}/S_{MF′}≥1.01.

19. The process of claim 16, wherein at least 1% of surface O_{A/MK} <181> is formed by O_{FΔ} <183> and/or at least 1% of surface O_{KK} <182> is formed by O_{FΔ} <183>.

20. The process of claim 16, wherein the alkali metal cation-conducting solid-state electrolyte ceramic F′ <19> has a structure of the formula:
M^{I}_{1+2w+x-y+z}M^{II}_{w}M^{III}ₓZr^{IV}_{2-w-x-y}M^{V}_{y}(SiO₄)_{z}(PO₄)_{3-z}
where M^{I} is selected from Na⁺ and Li⁺;
M^{II} is a divalent metal cation;
M^{III} is a trivalent metal cation;
M^{V} is a pentavalent metal cation;
the Roman indices I, II, III, IV, V indicate the oxidation numbers in which the respective metal cations exist;
wherein w, x, y, z are real numbers, and wherein 0≤x<2, 0≤y<2, 0≤w<2, 0≤z<3;
and wherein w, x, y, z are chosen such that 1+2w+x−y+z≥0 and 2−w−x−y≥0.

21. The process of claim 16, wherein X is selected from the group consisting of Li⁺, Na⁺, and K⁺.

22. The process of claim 21, wherein X=Na⁺.

23. The process of claim 16, wherein S is a halide, sulfate, sulfite, nitrate, hydrogencarbonate or carbonate of X.

24. The process of claim 23, wherein S is a chloride of X.

25. The process of claim 16, wherein R is selected from the group consisting of methyl and ethyl.

26. The process of claim 25, wherein R=methyl.

27. The process of claim 16, wherein the connection V_{AM} <15> is formed within the electrolysis cell E <1>.

28. The process of claim 16, wherein the connection V_{AM} <15> is formed outside the electrolysis cell E <1>.

29. The process of claim 16, wherein O_{A/MK} <181> and O_{KK} <182> comprise at least a portion of O_{FΔ} <183>.

30. The process of claim 29, wherein at least 1% of the surface O_{A/MK} <181> is formed by O_{FΔ} <183> and at least 1% of the surface O_{KK} <182> is formed by O_{FΔ} <183>.

31. The process of claim 19, wherein the alkali metal cation-conducting solid-state electrolyte ceramic F′ <19> has a structure of the formula:
M^{I}_{1+2w+x-y+z}M^{II}_{w}M^{III}ₓZr^{IV}_{2-w-x-y}M^{V}_{y}(SiO₄)_{z}(PO₄)_{3-z}
where M^{I} is selected from Na⁺ and Li⁺;
M^{II} is a divalent metal cation;
M^{III} is a trivalent metal cation;
M^{V} is a pentavalent metal cation;
the Roman indices I, II, III, IV, V indicate the oxidation numbers in which the respective metal cations exist;
wherein w, x, y, z are real numbers, where 0≤x<2, 0≤y<2, 0≤w<2, 0≤z<3;
and wherein w, x, y, z are chosen such that 1+2w+x−y+z≥0 and 2−w−x−y≥0.

32. The process of claim 31, wherein X is selected from the group consisting of Li⁺, Na⁺, K⁺.

33. The process of claim 32, wherein X=Na⁺.

34. The process of claim 32, wherein S is a halide, sulfate, sulfite, nitrate, hydrogencarbonate or carbonate of X.

35. The process of claim 34, wherein S is a chloride of X and R is selected from the group consisting of methyl and ethyl.
